(19) United States
(12) Patent Application Publication
(10) Pub. No.: US 2004/0182592 A1
(43) Pub. Date: Sep. 23, 2004

(54) Electrical box hanger

(75) Inventors: Steven J. King, Old Saybrook, CT (US); Scott A. King, Durahm, CT (US)

Correspondence Address: George N. Chaclas, Edwards & Angell, LLP, P. O. Box 55874, Boston, MA, 02205, US

(73) Assignee: King Electrical Contractors, LLC.

(21) Appl. No.: 10/803,769

(22) Filed: Mar. 18, 2004

Related U.S. Application Data
(60) Provisional application No. 60/455,449, filed on Mar. 18, 2003.

(51) Int. Cl. H01H 9/02

(52) U.S. Cl. 174/58

(57) ABSTRACT

A hanger assembly 100 couples to a T-bar grid for supporting an electrical box 104. The hanger assembly 100 includes an elongated support bar 106 having a male portion 108 that telescopes within a female portion 110 for varying the length of the elongated support bar 106. A pair of vertical supports 112 couple to the T-bar grid 102 and have a plurality of mounting positions 114 for setting a height between the elongated support bar 106 and a ceiling tile mounted within the T-bar grid 102. The vertical supports 112 also allow for aslant mounting of the elongated support bar 106. A support bracket 118 mounts the electrical box 104 to the elongated support bar 106 and a pair of tile supports 120 extend between the elongated support bar 106 and the ceiling tile 116 on each side of the electrical box 104.

### CROSS-REFERENCE TO RELATED APPLICATION

This application claims priority to U.S. Provisional Patent Application No. 60/455,449, filed Mar. 18, 2003, which is incorporated herein by reference in its entirety.

### BACKGROUND OF THE INVENTION

1. Field of the Invention

The subject disclosure relates to devices for supporting items within a ceiling, and more particularly to an improved system for flush mounting electrical boxes within drop ceilings having T-bar configurations.

2. Background of the Related Art

Use of electrical boxes to support ceiling features such as exit signs, smoke alarms, temperature sensors and the like is widely known and well understood by those of ordinary skill in the art. Typically, it is desirable to provide easy, cost-effective and aesthetically acceptable hardware for the mounting of such features. For drop ceilings having T-grids, various hangers and fasteners have been used to mount the electrical boxes which support these features. For examples, see U.S. Pat. Nos. 5,386,959 and 5,619,263. U.S. Pat. No. 5,619,263 discloses a typical box hanger 10 including a strut 50 that mounts to a T-bar grid by a pair of fingers 65. The strut 50 couples to a clip 20 to mount an electrical box 90 thereto.

Referring to FIG. 1, the traditional technique for attempting to flush mount the electrical box 90 within the ceiling tiles 40 is shown. If the electrical box 90 is too high, the ceiling tile 40 will lift or bow upwards when the feature is mounted thereto. When the electrical box is too low, a gap will form. To address this problem, the worker usually shims the feature flush by wedging scrap ceiling tile pieces 30 between the strut 50 and the ceiling tile 40. Despite the skill of the worker, use of the scrap ceiling tile pieces 30 rarely, if ever, results in a flush mounting of the desired feature.

Moreover, over time, the scrap pieces compress and require readjustment. Additional support is required but the additional support comes with unwanted complexity and cost. Still further, as the size of the electrical box 90 varies, a different strut 50 is required to set the electrical box 90 at approximately the correct height above the ceiling tiles 40. As a result, the worker needs a variety of box hangers for any given work site. Additionally, no accommodation for non-standard mounting of the strut 50 can be made so that many desirable locations for mounting the electrical box 90 must be avoided due to the shortcomings of the box hanger. Moreover, it is often desirable to locate “EXIT” signs and the like adjacent to doorways. However, as the T-bar grid approaches a wall, the spacing between bars becomes non-standard. Consequently, the item to mounted is placed in an undesirable location because of the limitations of the hanger assembly.

Devices have also been developed to mount ceiling fans, electrical boxes and the like in existing buildings with sheetrock or lathe ceilings. Such devices rely on the strength of the existing ceiling to help support the item. Moreover, different size electrical boxes cannot be accommodated. Commonly, the lathe ceiling devices incorporate mounts for engaging to studs. The mounts cannot be used interchangeably on studs and T-bar grids. The complexity and inconvenience of prior art hangers has been further complicated by the inability to ship and stock preassembled units.

There is a need, therefore, for an improved hanger that permits easy installation, provides adequate adjustment for a wide variety of applications and aids in assuring aesthetics and adequately supported mounting of electrical boxes and like items.

### SUMMARY OF THE INVENTION

A preferred embodiment of the present disclosure is directed to a hanger assembly for flush mounting an electrical box within a ceiling tile supported by a T-bar grid. The hanger assembly includes an elongated support having a pair of opposing ends, each end being adapted and configured to mount to a T-bar grid and at least one tile support coupled to the elongated support such that the at least one tile support adjustably extends between the elongated support and a ceiling tile.

It is an object of the present disclosure to provide a hanger assembly which quickly and easily mounts to the T-bar grid without the need for tools and/or preassembly. It is another object of the present disclosure to allow for easy height adjustments without requiring measurements or additional components. It is another object of the present disclosure to support multiple electrical box sizes wherein the electrical boxes may be mounted to the hanger assembly prior to installation.

Another preferred embodiment of the subject disclosure is a hanger assembly for allowing coupling an electrical box to a T-bar grid. The hanger assembly includes an elongated support bar having a variable length and a pair of vertical supports, each vertical support having a lower portion connected to an upper portion so that the upper portion may rotate with respect to the lower portion such that the elongated support bar may be mounted aslant with respect to a T-bar grid. The lower portion of the vertical supports is adapted and configured to mount to the T-bar grid and the upper portion of the vertical supports is adapted and configured to engage the elongated support bar.

It is another object of the present disclosure to allow for the use of independent drop wires for additional support. It is another object of the present disclosure to provide a hanger assembly which can support multiple box assemblies. It is another object of the present disclosure to provide a hanger assembly which prevents ceiling tile lift when mounting a feature to the hanger assembly. It is still another object of the present disclosure to provide a hanger assembly that can be utilized for stud mounting or T-bar grid mounting while maintaining other advantages disclosed herein.

Still another preferred embodiment of the subject disclosure is a hanger assembly for flush mounting an item within a ceiling, the hanger assembly including an elongated support having a variable length. The hanger assembly also includes a pair of vertical supports, each support having a lower portion for coupling to the T-bar grid and an upper portion for engaging the elongated support such that a height between the elongated support and a ceiling tile is adjustable as well as at least one tile support coupled to the elongated support for supporting the ceiling tile.

It should be appreciated that the present invention can be implemented and utilized in numerous ways, including without limitation as a process, an apparatus, a system, a device and a method for applications now known and later developed. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the drawings.

FIG. 1 is a perspective view of an installed prior art electrical box hanger assembly.

FIG. 2 is a front plan view of a hanger assembly constructed in accordance with the subject disclosure.

FIG. 3A is a detailed side view of the elongated support bar constructed in accordance with the embodiment of FIG. 2.

FIG. 3B is a detailed bottom view of the elongated support bar constructed in accordance with the embodiment of FIG. 2.

FIG. 3C is a cross-sectional view of the elongated support bar of FIG. 3B taken along line C-C.

FIG. 3D is a cross-sectional view of the elongated support bar of FIG. 3B taken along line D-D.

FIG. 3E is a detailed top view of the male portion of the elongated support bar constructed in accordance with the embodiment of FIG. 3A.

FIG. 3F is a detailed top view of the elongated support bar constructed in accordance with the embodiment of FIG. 3A.

FIG. 3G is a detailed top view of another preferred outer portion of an elongated support bar constructed in accordance with the subject disclosure.

FIG. 3H is a detailed side view of the elongated support bar of FIG. 3H in use.

FIG. 4A is a detailed side view of a vertical support constructed in accordance with a preferred embodiment of the subject disclosure.

FIG. 4B is a detailed front view of the vertical support of FIG. 4A.

FIG. 4C is a cross-sectional view of the vertical support of FIG. 4B taken along line C-C.

FIG. 5A is a detailed side view of a tile support constructed in accordance with the embodiment of FIG. 2.

FIG. 5B is a detailed top view of the tile support of FIG. 5A.

FIG. 6A is an assembled side view of a support bracket constructed in accordance with the embodiment of FIG. 2.

FIG. 6B is a detailed top view of the box portion of the support bracket of FIG. 6A.

FIG. 6C is a detailed side view of the box portion of the support bracket of FIG. 6A.

FIG. 6D is a detailed side view of the bar portion of the support bracket of FIG. 6A.

FIG. 6E is a detailed top view of the bar portion of the support bracket of FIG. 6A.

FIG. 7A is a detailed side view of another vertical support constructed in accordance with a preferred embodiment of the subject disclosure.

FIG. 7B is a detailed front view of the vertical support of FIG. 7A.

FIG. 8A is a detailed side view of the vertical support of FIG. 2.

FIG. 8B is a detailed front perspective view of the vertical support of FIG. 8A.

FIG. 9 is a detailed side view of another vertical support constructed in accordance with a preferred embodiment of the subject disclosure.

FIG. 10 is a detailed side view of another vertical support constructed in accordance with a preferred embodiment of the subject disclosure.

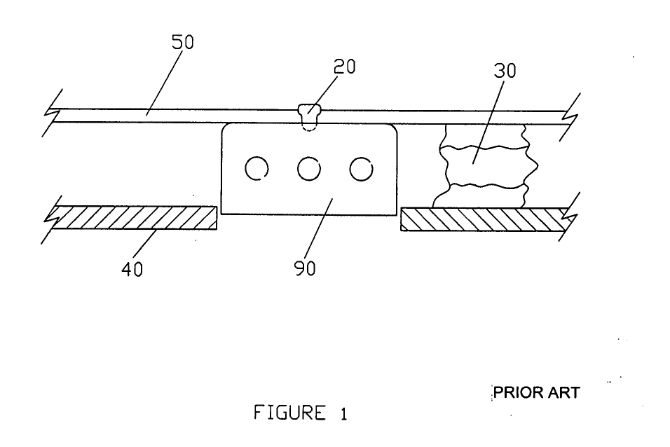

### DETAILED DESCRIPTION OF PREFERRED EMBODIMENTS

The present invention overcomes many of the prior art problems associated with electrical box hangers. The advantages, and other features of the systems disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

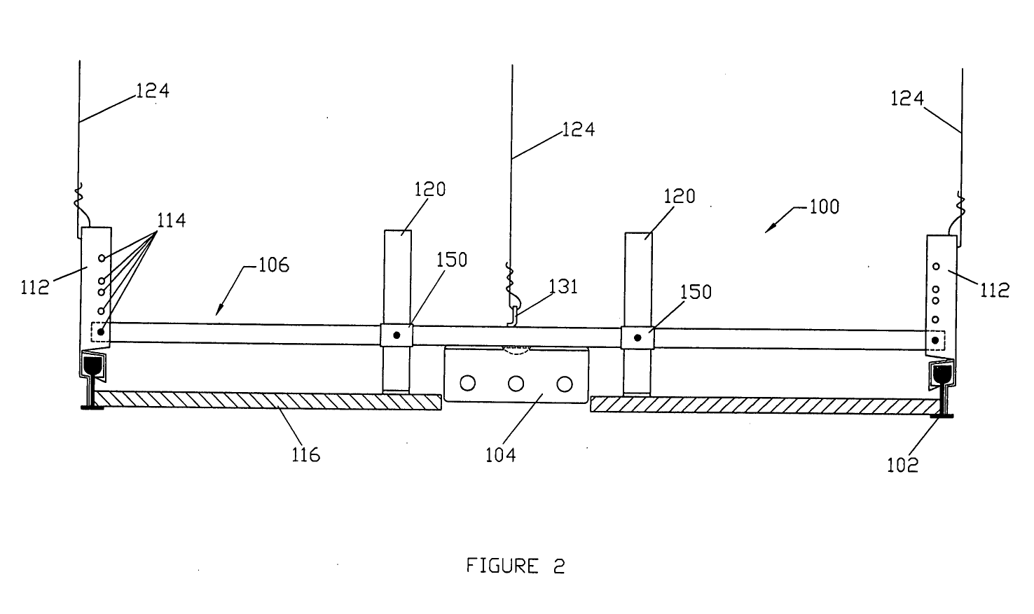

Referring to FIG. 2, a hanger assembly 100 couples to a T-bar grid 102 for supporting an electrical box 104. The hanger assembly 100 has a pair of adjustable height vertical supports 112 for setting electrical boxes of various sizes at the desired position with respect to ceiling tiles 116. The hanger assembly 100 also has an adjustable length elongated support bar 106 for spanning between variously spaced T-bar grids. When mounted, tile supports 120 coupled to the elongated support bar 106 brace the ceiling tile 116.

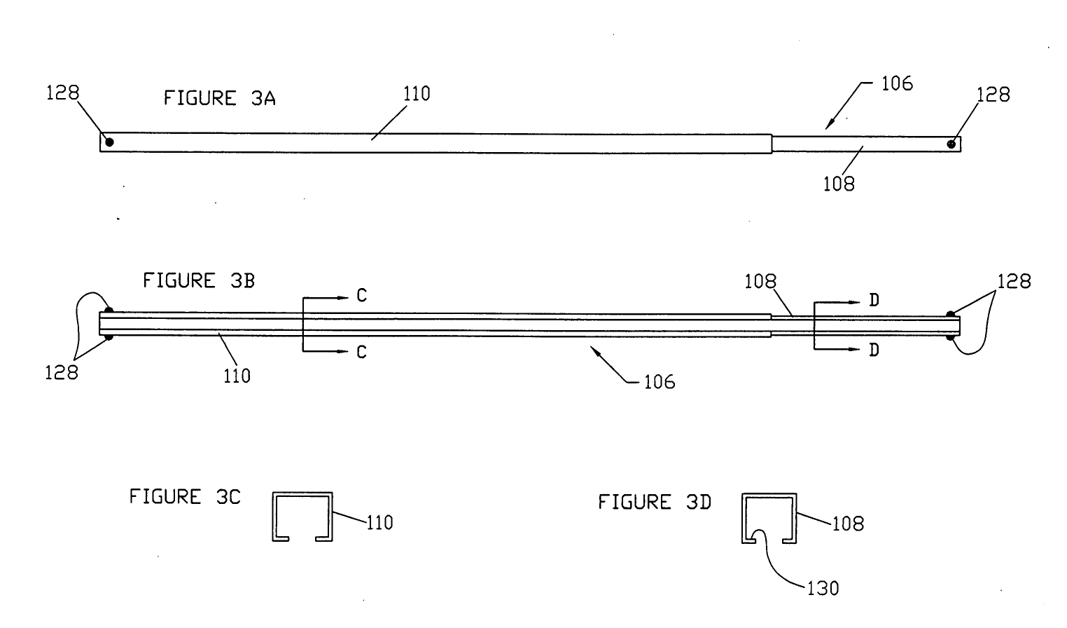

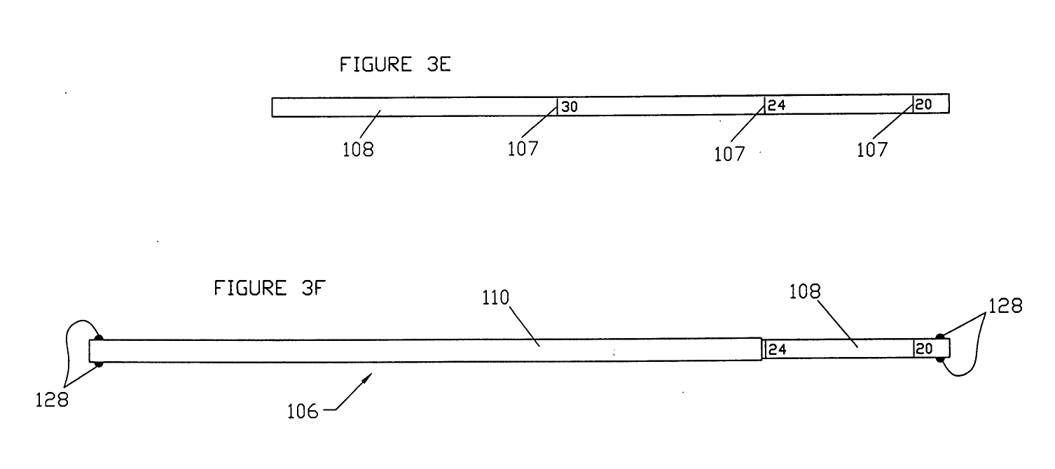

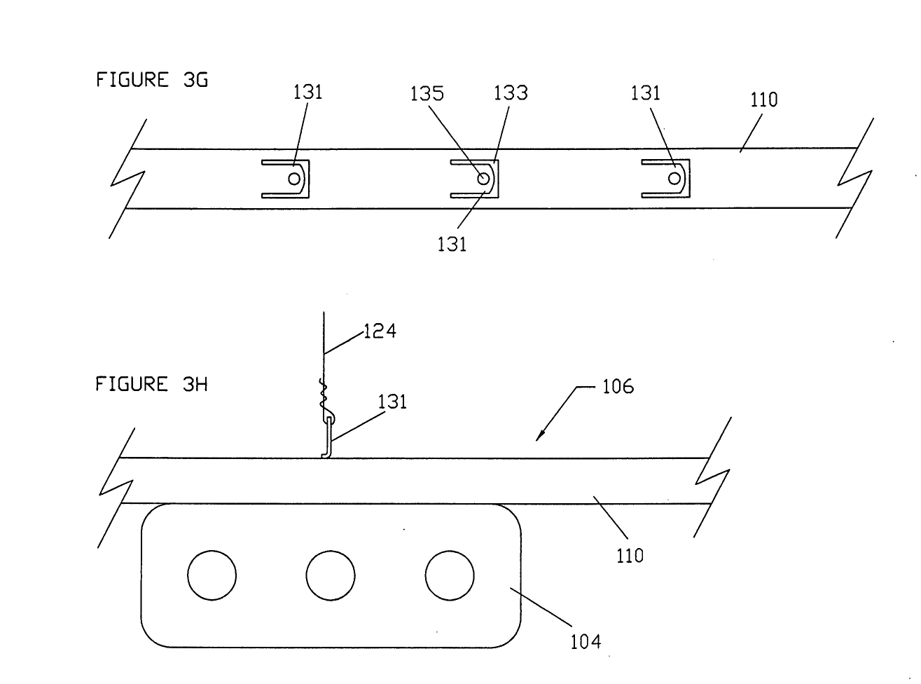

Referring to FIGS. 3A-3F, the hanger assembly 100 includes an elongated support bar 106 having a male portion 108 which telescopes within a female portion 110 for varying a length of the elongated support bar. In cross-section, the elongated support bar 106 forms a channel slot 130 for mounting the electrical box 104 thereto. On each end of the elongated support bar 106 are a pair of opposing pushpins 128 for engaging the vertical supports 112. The pushpins 128 are preferably spring-biased to allow quick adjustment and assembly of the elongated support bar without tools. The male portion 108 includes indicia 107 for setting the length of the elongated support bar 106 as desired such as one of the standard 20, 24 or 30 inch T-bar grid spans. As a result, a single hanger assembly 100 can be utilized for a plurality of different T-bar grid spans without requiring measurements.

In a preferred embodiment, the male portion 108 and the female portion 10 are both 17 inches long. Such an elongated support bar 106 can vary more from less than 20 inches to more than 30 to extend across the standard spacing of T-bar grids. In another embodiment, the male portion 108 and the female portion 110 are of different lengths. In still another embodiment, the male and female portions 108, 110 have a series of mounting holes along complementary surfaces, wherein the mounting holes receive fasteners to rigidly fix the length of the elongated support bar. In still another embodiment, the elongated support bar 106 is monolithic.

Referring to FIGS. 3G and 3H, another female portion 110 of an elongated support bar 106 has a plurality of tabs 131 formed therein by stamping a u-shaped slot 133 into the female portion 110. Stamping allows the tabs 131 to remain flush which prevents interference when the male portion 108 telescopes within the female portion 10. During the stamping process, apertures 135 are also formed to receive a support wire 124 (see FIG. 2). The support wire provides additional support for the electrical box 104. Preferably, the spacing between each tab 131 is approximately 2 inches to allow bending up a tab 131 near the location of the electrical box 104.

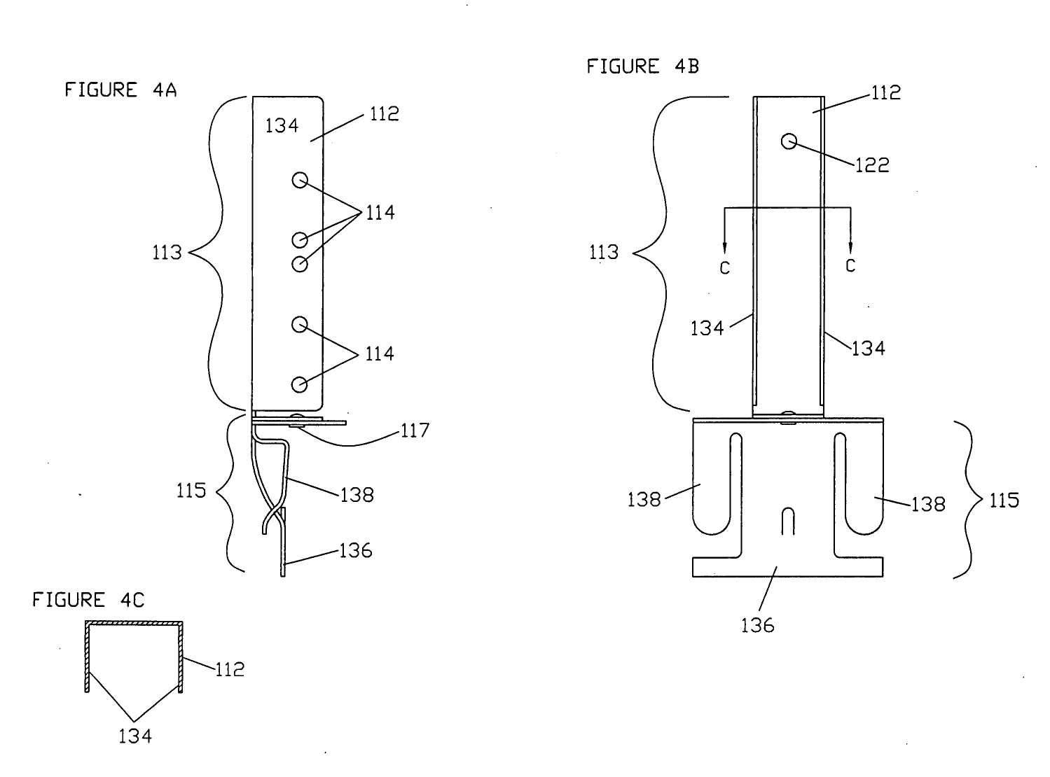

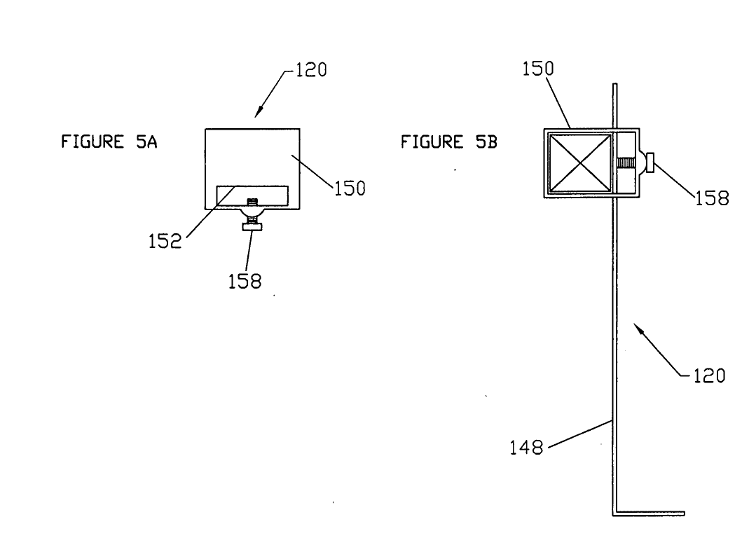

Now referring to FIGS. 4A-4C, each vertical support 112 is substantially identical, thus for simplicity only one is shown and described herein. In a preferred embodiment, the vertical support 112 has an upper portion 113 and a lower portion 115. The upper portion 113 has opposing sidewalls 134 for engaging the elongated support bar 106 and the lower portion 115 has opposing fingers 136, 138 for engaging the T-bar grid 102.

The upper portion 113 and lower portion 115 are connected by a pivot point 117. The pivot point 117 allows the upper portion to rotate with respect to the lower portion 115 for mounting the elongated bar 106 aslant rather than parallel or perpendicular to the T-bar gird 102. Thus, the hanger assembly 100 can be mounted in non-standard spacing, between non-parallel members and around obstructions. In a preferred embodiment, the pivot point 117 is a rivet. In another embodiment, the pivot point 117 is a fastener such as a screw.

To couple the elongated support bar 106 to the vertical support 112, five mounting holes 114 are formed in the opposing sidewalls 134 of the upper portion 113 although it is appreciated that more or less mounting holes may be provided as required. The mounting holes 114 releasably receive the pushpins 128 of the elongated support bar 106. As a result, the elongated support bar 106 can be mounted at a plurality of heights on the vertical support 112 according to a depth of the electrical box 104. Preferably, a plurality of indicia (not shown) are provided on the vertical support 112 to identify the heights of the mounting apertures 114 for setting the elongated support bar 106 to the desired height. As a result, the desired height can be set prior to installation without measurement. The sidewalls 134 of the vertical supports 112 also define a hole 122 for receiving a support wire 124 as seen in FIG. 2.

To couple the vertical support 112 to the T-bar grid 102, the lower portion 115 has a first finger 136 opposed by a second finger 138. The fingers 136, 138 are configured to fixedly snap onto the T-bar grid 102. The shape of the vertical support 112 allows lifting adjacent ceiling tiles without likelihood of damage.

Referring now to FIGS. 5A and 5B, each tile support 120 is substantially identical, thus for simplicity only one is shown and described. The tile support 120 includes a collar 150 that slides over the elongated support bar 106 to position the tile support 120 at a desired location thereon. A spacer bar 148 passes through slots 152 (only one shown) defined by the collar 150. A lower end 156 of the spacer bar 148 abuts the ceiling tile 116 for support. When the tile support 120 and spacer bar 148 are in the desired position on the elongated bar 106, a set screw 158 or like fastening means fixes the position thereof. In another embodiment, the spacer bar 148 includes a rubber boot on the lower end 1156 to protect the ceiling tile 116. In another embodiment, the spacer bar 148 includes ruled markings or indicia to allow presetting a height thereof according to the depth of the electrical box 104.

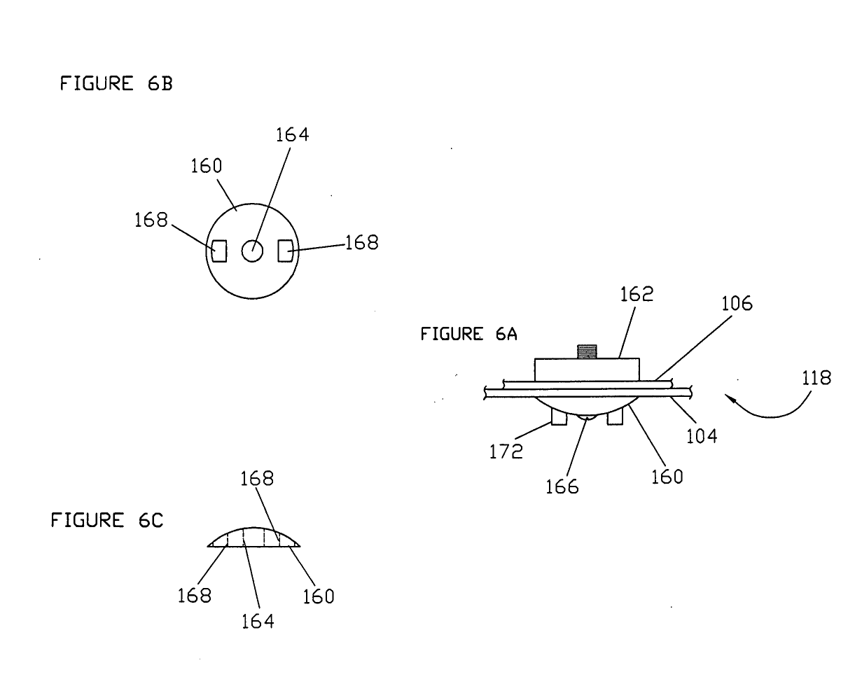

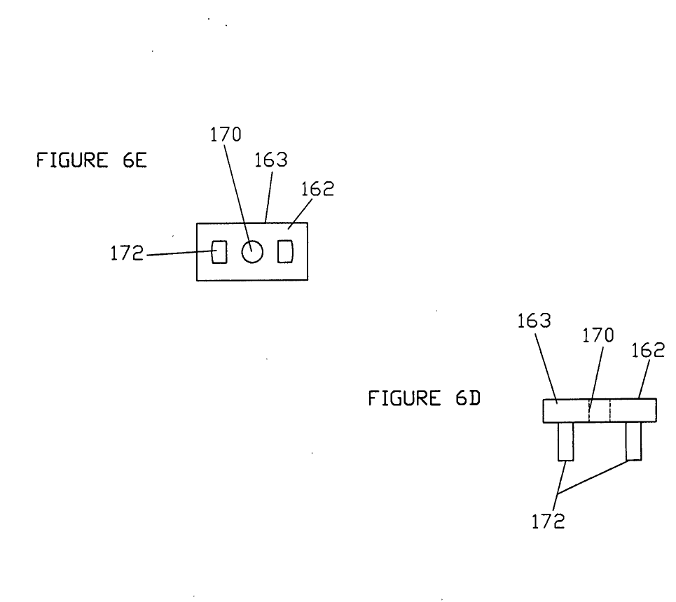

Referring to FIGS. 6A-6E, a support bracket 118 slidably mounts the electrical box 104 to the elongated support bar 106 by coupling with the channel slot 130 of the elongated support bar 106. The support bracket 118 also allows rotation of the electrical box 104 for squaring up the electrical box 104 to the T-bar grid 102 when the elongated bar 106 is aslant. The support bracket 118 includes a box portion 160 that fits within the electrical box 160 and a bar portion 162 that couples to the elongated support bar 106.

The box portion 160 defines a central opening 164 for receiving a fastener 166. The fastener 166 sets the electrical box 104 in the desired location and orientation. The box portion 160 also defines two channels 168 for coupling to the bar portion 162. The bar portion 162 has a body portion 163 that defines a threaded central aperture 170 for receiving the fastener 166. The body portion 163 is sized and configured such that upon insertion within the channel 130 of the elongated support bar 106, the body portion 163 will not fall out as a failsafe. Two posts 172 depend from the body portion 163 for coupling to the channels 168 of the box portion 160. In another embodiment, the support bracket 118 has large slots 168 to accommodate rotational adjustment of the electrical box 104. In still another embodiment, the support bracket 118 does not have posts 172 to allow for rotational adjustment of the electrical box 104.

To mount the electrical box 104 to the support bar 106, the body portion 163 of the bar portion 162 is placed within the channel slot 130 and the box portion 160 is placed within the electrical box 104. The electrical box 104 defines holes (not shown) for passing the posts 172 through and into the channels 168. The fastener 166 may then be used to loosely couple the box portion 160 to the bar portion 162 and, in turn, slidably engage the electrical box 104 to the support bar 106. When the electrical box is in the desired position, the fastener 166 is tightened to compress the box portion 160 and bar portion 162 together to fix the position and orientation of the electrical box 104 to the support bar 106.

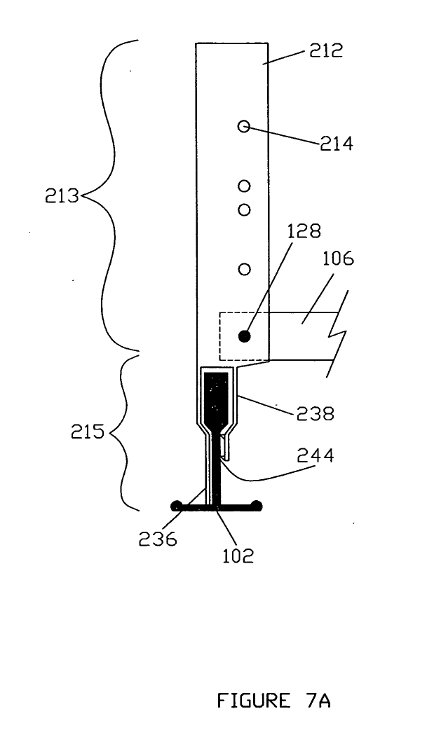

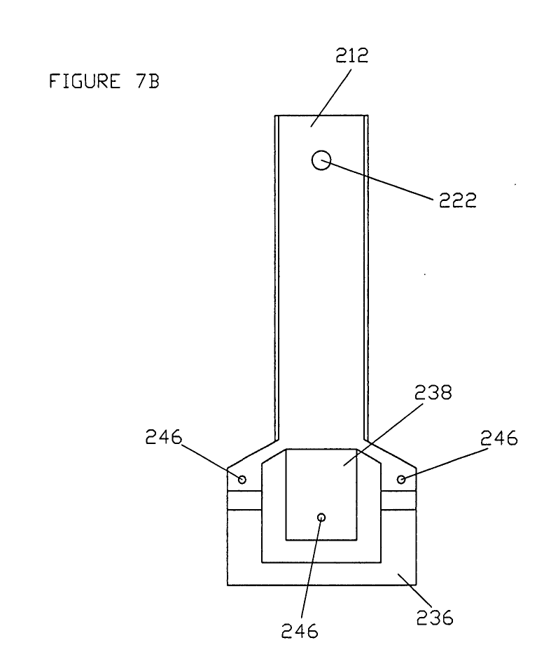

Referring now to FIGS. 7A and 7B, as will be appreciated by those of ordinary skill in the pertinent art, the vertical support 212 utilizes the same principles of the vertical support 212 described above. Accordingly, like reference numerals preceded by the numeral “2” instead of the numeral “1”, are used to indicate like elements whenever possible. The vertical support 212 has an upper portion 213 integral with the lower portion 215. The lower portion 215 forms a pair of opposing fingers 236, 238 for engaging the T-bar grid 102. The fingers 236, 238 define a slot therebetween for receiving a T-bar grid 102 in a friction fit. One or both of the fingers 236, 238 may include barbs 244 to further improve the vertical support 212 attachment to the T-bar grid 102. The fingers 236, 238 also define fastener holes 246 for allowing mounting the vertical support 212 to the T-bar grid 102 for still further additional support. In still another embodiment, the fingers 236, 238 may include rubber boots to prevent damage to ceiling tiles during installation, removal and the like.

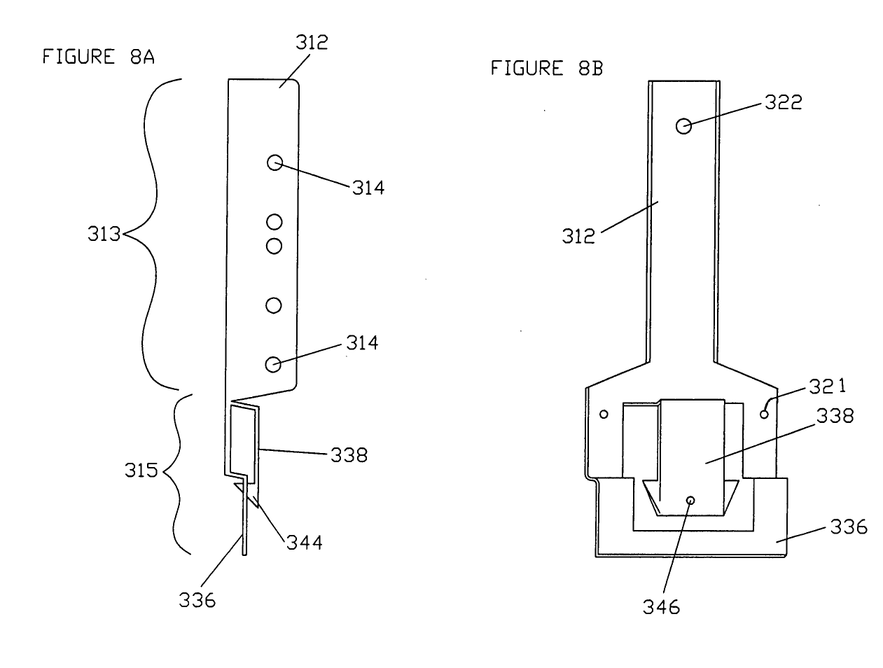

Referring now to FIGS. 8A and 8B, as will be appreciated by those of ordinary skill in the pertinent art, the vertical support 312 utilizes the same principles of vertical supports 112, 212 described above. Accordingly, like reference numerals preceded by the numeral “3” instead of the numerals “1” or “2”, are used to indicate like elements whenever possible. The vertical support 312 has an upper portion 313 integral with the lower portion 315. The lower portion 315 forms a pair of opposing fingers 236, 238 for engaging the T-bar grid 102. The finger 338 includes a relatively large single barb 344 to further improve the vertical support 312 attachment to the T-bar grid 102. The vertical support 312 also defines mounting holes 321 for receiving a fastener to attach the vertical support 312 to a wooden stud or other structure. As a result, the hanger assembly 100 of the subject disclosure can be utilized with a T-bar grid or other existing ceiling structure.

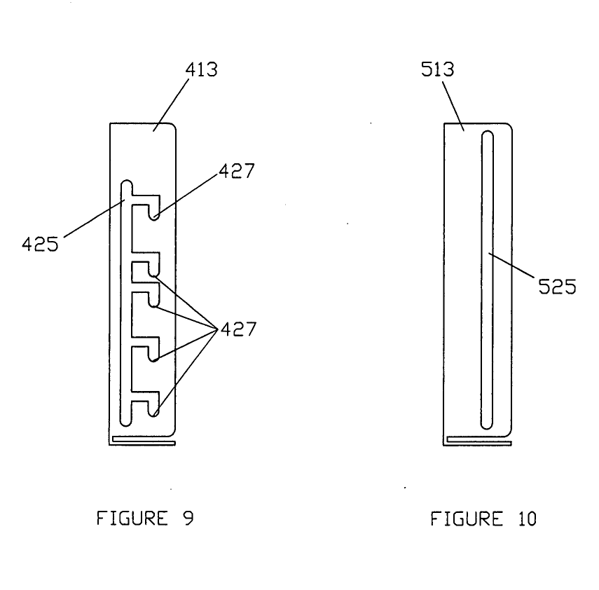

Referring now to FIG. 9, as will be appreciated by those of ordinary skill in the pertinent art, the upper portion 413 of a vertical support utilizes the same principles of upper portions 113, 213, 313 described above. Accordingly, like reference numerals preceded by the numeral “4” instead of the numerals “1”, “2” or “3”, are used to indicate like elements whenever possible. The upper portion 413 forms an elongated slot 425 having a series of landing positions 427. Preferably, the elongated support bar 106 includes opposing posts (not shown) instead of opposing pushpins 128. The landing positions 427 receive the opposing posts to set the height of the elongated support bar 106.

Referring now to FIG. 10, as will be appreciated by those of ordinary skill in the pertinent art, the upper portion 513 of a vertical support utilizes the same principles of upper portions 113, 213, 313, 413 described above. Accordingly, like reference numerals preceded by the numeral “5” instead of the numerals “1”, “2”, “3” or “4”, are used to indicate like elements whenever possible. The upper portion 513 forms an elongated slot 525. Preferably, the elongated support bar 106 includes a threaded hole (not shown) instead of opposing pushpins 128. To set the height of the elongated support bar 106, a wing bolt (not shown) or like fastener threads through the slot 525 into the threaded hole of the elongated support bar 106.

It can be seen from the disclosure that the subject hanger assemblies can be assembled at the factory for easy use. The vertical supports 112 can be set to the height that matches the electrical box 104 attached thereto and rotated parallel to the elongated support bar 106. The tile supports can be removed. In another preferred embodiment, the tile supports include two plates riveted together to form a pivot point that allow for rotation thereof. In another embodiment, the tile supports include a slotted channel that is captured by a screw in the elongated support bar to allow rotation and fixing. As a result, the hanger assembly, including the tile supports, folds into a very compact shape for shipment and display even though the hanger assembly is fully assembled. Moreover, most or all of the adjustments and couplings do not require tools. In another embodiment, multiple electrical boxes or like items are mounted on the elongated support bar 106.

While the invention has been described with respect to preferred embodiments, those skilled in the art will readily appreciate that various changes and/or modifications can be made to the invention without departing from the spirit or scope of the invention. Moreover, although the disclosed embodiments have been illustrated and described with dimensions, it will be appreciated by those of ordinary skill in the pertinent art that such dimensions are for example and in no way intended to limit the scope of the invention as defined by the appended claims.

What is claimed is:

1. A hanger assembly for flush mounting an electrical box within a ceiling tile supported by a T-bar grid, the hanger assembly comprising:
an elongated support having a pair of opposing ends, each end being adapted and configured to mount to a T-bar grid; and
at least one tile support coupled to the elongated support such that the at least one tile support adjustably extends between the elongated support and a ceiling tile.

2. A hanger assembly as recited in claim 1, wherein the at least one tile support can be selectively fixed along a length of the elongated support.

3. A hanger assembly as recited in claim 1, wherein the at least one tile support is two tile supports.

4. A hanger assembly as recited in claim 1, wherein the at least one tile support includes
a collar slidably mounted on the elongated support for positioning the tile support at a desired location thereon, the collar defining a slot; and
a spacer bar passing through the slot such that a lower end of the spacer bar can support a ceiling tile.

5. A hanger assembly as recited in claim 1, further comprising a vertical support portion having means for varying a distance between the ceiling tile and the elongated support when mounted.

6. A hanger assembly as recited in claim 5, wherein the means is at least two holes formed in the vertical support portion.

7. A hanger assembly as recited in claim 1, further comprising a vertical support portion having a pivot for mounting the elongated support at a plurality of angles between two substantially parallel T-bars and a support bracket for selectively mounting an electrical box.

8. A hanger assembly as recited in claim 1, wherein the elongated support includes a first portion and a second portion coupled to the first portion for selectively adjusting a length of the elongated support.

9. A hanger assembly as recited in claim 8, further comprising a plurality of tabs formed in the first portion for selectively engaging a support wire.

10. A hanger assembly as recited in claim 8, further comprising indicia on the second portion for determining a length of the elongated support.

11. A hanger assembly for mounting an electrical box within a ceiling, the hanger assembly comprising: an elongated support bar having a variable length; and a pair of vertical supports, each vertical support having a lower portion connected to an upper portion so that the upper portion may rotate with respect to the lower portion such that the elongated support bar may be mounted aslant, the lower portion being adapted and configured to mount to the ceiling and the upper portion being adapted and configured to engage the elongated support bar.

12. A hanger assembly as recited in claim 11, further comprising at least one tile support coupled to the elongated support bar that can be selectively adjusted to extend between the elongated support bar and a ceiling tile.

13. A hanger assembly as recited in claim 11, further comprising a support bracket for selectively mounting an electrical box to the elongated support.

14. A hanger assembly as recited in claim 13, wherein the support bracket allows for rotation of the electrical box.

15. A hanger assembly as recited in claim 11, wherein the elongated support bar includes a male portion telescopingly connected to a female portion.

16. A hanger assembly as recited in claim 11, further comprising means on each upper portion of the vertical supports for adjusting a height between the elongated support bar and a ceiling tile.

17. A hanger assembly as recited in claim 16, wherein the means is at least two holes formed in the upper portions.

18. A hanger assembly as recited in claim 11, wherein the lower portion mounts to a group of ceilings consisting of ceilings having T-bar grids and ceilings having wood studs.

19. A hanger assembly for flush mounting an item within a ceiling, the hanger assembly comprising:
an elongated support having a variable length;
a pair of vertical supports, each support having a lower portion for coupling to the ceiling and an upper portion for engaging the elongated support such that a height between the elongated support and the ceiling is adjustable; and
at least one tile support coupled to the elongated support for supporting the ceiling tile.

20. A hanger assembly as recited in claim 19, wherein the at least one tile support can be selectively fixed along the elongated support and the at least one tile support adjustably extends between the elongated support and the ceiling.

21. A hanger assembly as recited in claim 19, further comprising a support bracket for selectively mounting the item to the elongated support.

22. A hanger assembly as recited in claim 21, further comprising an electrical box slidably mounted to the elongated support bar by the support bracket.

23. A hanger assembly as recited in claim 21, further comprising a second electrical box slidably mounted to the elongated support bar by the support bracket.

24. A hanger assembly as recited in claim 21, wherein the support bracket includes an item portion adjacent to the item, the item portion defining a central opening for receiving a fastener to set the item in a desired location and orientation, and an elongated support portion for coupling to the elongated support bar, the elongated support portion defining a central aperture for receiving the fastener

25. A hanger assembly as recited in claim 21, wherein the support bracket includes a body portion is sized and configured such that upon slidably fastening to the elongated support, the support bracket is retained to the elongated support.

26. A hanger assembly as recited in claim 19, wherein the elongated support has first and second portions of same length and the first portion is slidably received within the second portion.

27. A hanger assembly as recited in claim 19, further comprising a pair of push pins on each end of the elongated support for engaging the upper portion of the vertical supports.

28. A hanger assembly as recited in claim 19, further comprising a plurality of flexible tabs substantially flushly formed in the elongated support, each tab defining an aperture for receiving a mounting wire, and having a portion that allows selectively positioning the tab to receive the mounting wire.

29. A preassembled hanger assembly for compact shipment and easy installation, the preassembled hanger assembly comprising:
an elongated support having a variable length, each end of the elongated support having first means for engaging; and
a pair of vertical supports, each support having a lower portion for coupling to the ceiling and an upper portion with second means for engaging the first means such that the pair of vertical supports can be rotated parallel to the elongated support for compact packaging of the preassembled hanger assembly.

30. A preassembled hanger assembly as recited in claim 29, further comprising at least one tile support coupled to the elongated support for supporting the ceiling tile and capable of being rotated parallel to the elongated support for packaging.

31. A preassembled hanger assembly as recited in claim 29, wherein the first means is a push button device and the second means is a pair of opposing apertures.
